(19) United States
(12) Patent Application Publication
(10) Pub. No.: US 2019/0320584 A1
(43) Pub. Date: Oct. 24, 2019

(54) HARVESTING DEVICE

(71) Applicant: Allegheny Genesis Holdings LLC, Nashville, TN (US)

(72) Inventor: Jordon Glen MASTERS, Morgantown, WV (US)

(21) Appl. No.: 16/299,297

(22) Filed: Mar. 12, 2019

Related U.S. Application Data
(60) Provisional application No. 62/643,342, filed on Mar. 15, 2018.

(51) Int. Cl. A01D 47/00

(52) U.S. Cl. CPC A01D 47/00

(57) ABSTRACT

In a method and apparatus for harvesting microgreens, plants are grown in individual trays. To harvest the tops of the live plants, a tray is placed at an angle to the horizontal that will allow upper portions of the plants that are harvested to fall naturally into a bin for collection. An automated cutting implement may be used to harvest the upper portions by moving over the tray at a selected distance above the tray.

### TECHNICAL FIELD

This invention relates to the art of devices for harvesting microgreens, shoots, baby greens, and the like.

### BACKGROUND ART

It is common to grow microgreens and similar food crops in trays with inserts that provide individual-sized containers of soil that are smaller than the tray itself. One example of a tray in common use is that known as a 1020-size flat and its associated inserts.

While large systems for harvesting crops grown in flats are known, those systems are typically designed for use in large settings, such as farms, and are too large and expensive for harvesting in smaller operations. For example, the increased emphasis on consumption of fresh foods in restaurants has made it desirable to maintain live plants of such crops as microgreens to permit the harvesting of individual servings of the edible portions only when a consumer has asked for them. It is also becoming commonplace for a restaurant to harvest these crops in the kitchen just before making a dish having one of them as an ingredient.

Accordingly, there is a need for a harvester capable of easily harvesting crops such as microgreens in a small setting and at reduced cost.

### SUMMARY OF THE INVENTION

In accordance with the invention, a “desktop” harvester for use in smaller, individualized situations is provided. The harvester can be operated manually or by one or more automated features. In a preferred embodiment, a crop tray support receives a crop tray, such as a 1020 flat, having live plants for harvesting a live crop. The crop tray support engages a crop tray to hold it in a position whereby the tops of the plants can be accessed easily by a cutting implement and the cut portions will fall into a collection bin naturally by gravity.

In one embodiment, the tray is held by the crop tray support at an angle of about 65° with respect to the horizontal. The crop tray support can be adjustable, however, to allow the angle of inclination to be changed.

The cutting implement can be a knife that extends partially or completely across a tray and is movable along the tray to cut the tops of the crops at a desired height. The knife can be operated manually or it can be automated. An automated knife could be attached to means, such as an electric motor, that causes the knife to oscillate in a direction across the crop tray as it moves in a transverse direction along the crop tray. Alternatively, the knife could be a continuous blade having a cutting edge that moves continuously in one direction across the upper parts of the live plants as well as in a transverse direction along the crop tray.

The cutting implement can be adjustable to allow the height at which it cuts the plants to be selected. Adjustments to the height can be made manually or can be driven by a stepper motor and lead screws. As well, robotic systems can be developed to control the cutting implement.

### BRIEF DESCRIPTION OF THE DRAWINGS

FIG. 1 is a front view of a harvesting device according to the invention in use.

FIG. 2 is a front perspective view of a harvesting device according to the invention.

FIG. 3 is a rear perspective view of a harvesting device according to the invention.

### DETAILED DESCRIPTION OF THE INVENTION

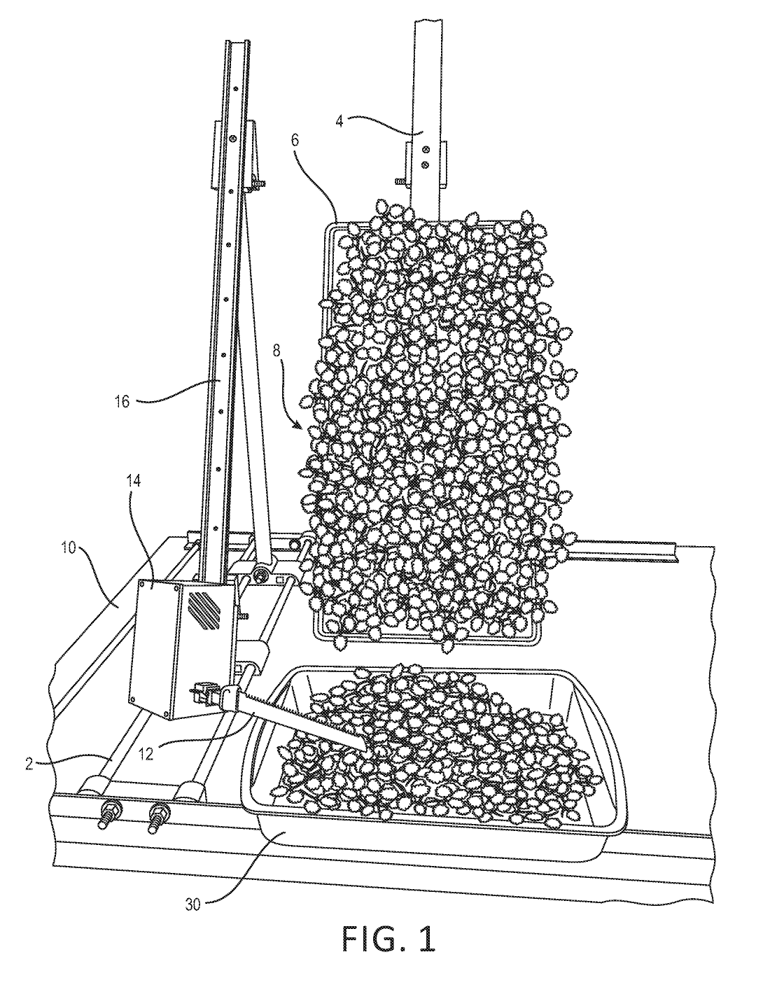

With reference to FIG. 1, a harvesting device according to the invention includes a base 2 that is preferably of a size that can be placed on a work table in a facility such as a restaurant. A first support bar 4 extends upward from the base in a position with respect to the base that it can engage the rear surface of a crop tray 6 to support the tray. The crop tray 6 may have several live plants 8 therein. The support bar 4 preferably holds the crop tray 6 at an angle of about 65° to the base, which can be supported on a horizontal surface of a work table 10.

The support bar can be a simple, narrow bar with a flat surface that engages the bottom of a crop tray. Alternatively, the support bar can provide a wider surface, such as a generally flat sheet, or it can include interlocking elements that mate with locking elements on the crop tray. The support bar could also include one or more high-friction portions or mechanical attachments to hold the crop tray securely.

Cutting implement 12, illustrated here as a serrated knife, is attached to an electric drive motor 14. The drive motor is in turn mounted to track 16, which is adjacent to the support bar 4 and extends generally parallel to it. The drive motor 14 is attached to track 16 by a sliding mount that permits movement of the drive motor and cutting implement along the track. The drive motor can also be rotated toward and away from the support bar whereby the knife can be moved away from the plants 8 to allow the crop tray to be placed on the support bar or removed from it. When a crop tray is in place the drive motor can be rotated to place the cutting implement into position for harvesting the plants by cutting the tops of the plants as the drive motor and cutting element are moved along track 16.

In the embodiment illustrated in FIG. 1 the length of the cutting implement 12 is about one-half the width of the crop tray 6 and as such does not cut all of the plants in the tray as the cutting implement is moved upwardly and the crop tray is in the orientation shown. The crop tray can, however, be rotated end-to-end to position the uncut plants such that the cutting implement can harvest them by another pass of the cutting implement. The length of the knife can be equal to the width of the crop tray, however

Alternatively, the track 16 could extend in a direction transverse to the support bar such that its motion is transverse to that shown in the figures.

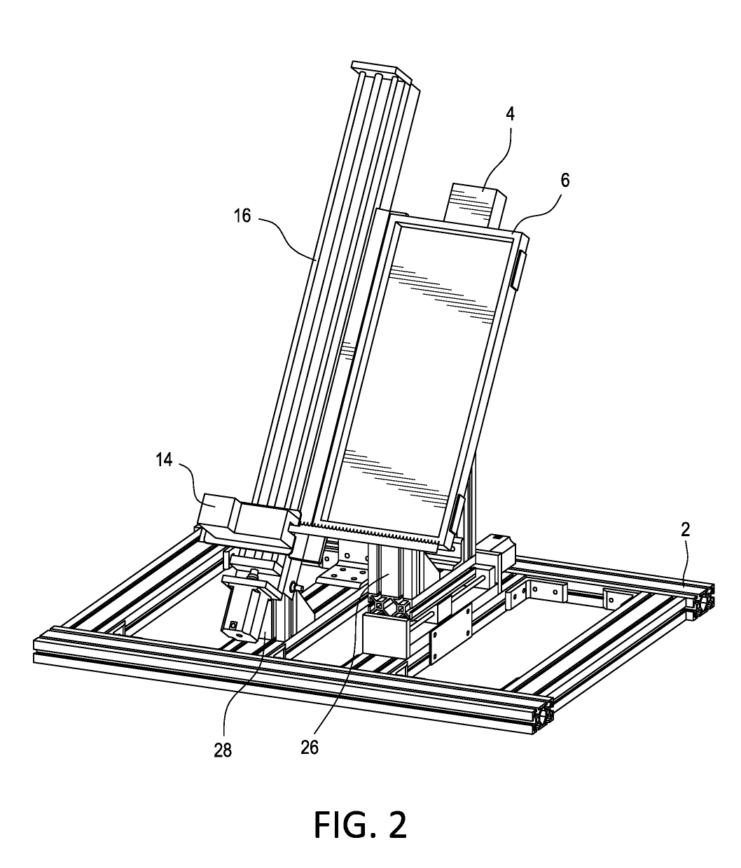

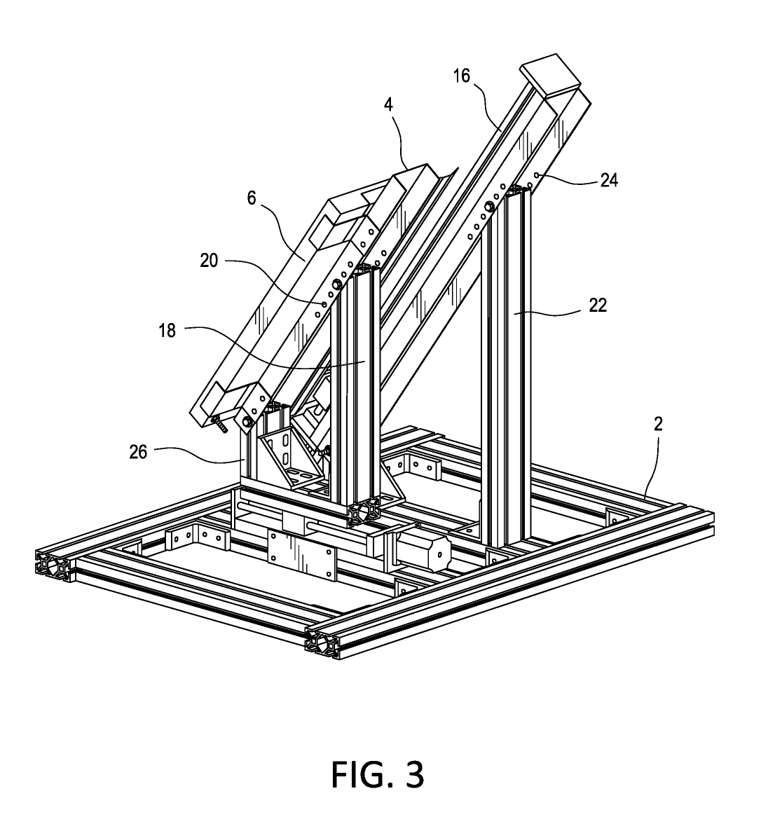

FIG. 2 is a schematic of an embodiment of the invention where the crop tray 6 is empty. FIG. 3 is a rear view of the embodiment shown in FIG. 2. As shown in FIG. 3, an orientation-adjustment leg 18 is attached to an upper portion of the support bar 4 at a selected one of the adjustment holes 20. A second orientation leg 22 is attached to an upper portion of the track 16 at a selected one of the adjustment holes 24. Each of the support bar 4 and the track 16 is supported by a respective bracket 26 and 28 that pivotally attaches one of the support bar 4 and the track 16 to the base 2.

In use, the harvester a crop tray 6 having plants 8 therein for harvesting is placed on the base 2 and supported by the support bar 4 at an angle of about 65 degrees with respect to the horizontal. The drive motor 14 is rotated to an operating position and activated to cause the cutting implement 12 to operate. A user then manually moves the drive motor upwardly along the track 16 to cut the tops of the plants, which then fall into a collection area, shown here as a bin 30, under the forces of gravity. The harvested crop is then removed from the collection area for consumption.

As noted above, if the tray 6 is wider than the cutting implement is long, the tray 6 can be rotated and the cutting implement again moved along the track to harvest the remaining plants in the tray.

While the tray 6 is preferably held at an inclination of 65 degrees to the horizontal, other angles are possible, depending on the character and size of the plants 8. Preferably, the angle of inclination is greater than 50 degrees. As well, the cutting implement can extend completely across the tray and can take a variety of forms, including a continuous-band type blade.

While the embodiment illustrated relies on manual movement of the drive motor, it is within the contemplation of the invention to provide the drive motor with a motor, such as a stepper motor, that engages the track 16 to move the cutting implement automatically.

The cutting height can either be adjusted manually or automatically. For example, the device of the invention could be provided with an optical, acoustical, or the like device that determines the height of the plants and adjusts the cutting height to be optimum for the type of plant, the plant's age, and the intended use of the harvested crop. Factors such as these can be input to an electronic system, such as a programmable computer to determine the optimum height and to provide a drive mechanism, such as a stepper motor, a rack-and-pinion system, or a drive-screw system with signals causing adjustment of the cutting height. Robotic systems may be used as well.

While the support bar and track are shown attached to a base, it is possible to attach these directly to an appropriate surface, such as a work table or stand, if portability is not a requirement. Of course, the work table or stand with the support bar and track mounted thereon could be portable.

The collection area can be any area adjacent the plants 8 into which the harvested portions of the plants can fall. For example, the collection area could simply be the area of a table on which the harvester sits that is just in front of the tray. Or it can be a bin 30 sitting on the table to facilitate transport of the harvested portions. One feature of the invention is that the tray 6 is held at an angle with respect to the horizontal that will allow the harvested portions of the plants to fall naturally from the plants onto the collection area. The collection area need not be horizontal, as the harvested portions could be collected in an area or a bin that is not horizontal, the harvested portions nevertheless falling into the collection area by gravity.

Modifications within the scope of the appended claims will be apparent to persons of skill in the art.

I claim:

1. A harvesting system comprising a tray support, a collection area, and a cutting implement, wherein said tray support is configured to receive a crop tray having plants therein and extends upwardly from the horizontal at an angle that allows harvested portions of said plants to fall into said collection area by gravity, said collection area is positioned adjacent said tray support, and said cutting implement is configured to cut said harvested portions.

2. A harvesting system according to claim 1 further comprising a track for movably supporting said cutting implement, said track being adjacent said tray support for guiding said cutting implement along a path for cutting said harvested portions.

3. A harvesting system according to claim 2 further comprising a bin in said collection area for receiving said harvested portions.

4. A harvesting system according to claim 3 further comprising a base for mounting said tray support, cutting implement, and track.

5. A harvesting system according to claim 1 wherein said angle is at least 50°.

6. A harvesting system according to claim 5 wherein said angle is about 65°.

7. A method for harvesting upper portions of live plants comprising the steps obtaining a tray containing said live plants, said growing plants being arranged in said tray with the root portions supported in said tray and said upper portions extending above an upper edge of said tray, placing said tray on a support that holds said tray at an angle of at least 50° with respect to the horizontal, placing an automated cutting implement at least partially across said tray at a predetermined distance above said upper edge of said tray, and activating said automated cutting implement to cut said upper portions from said live plants.

8. A method according to claim 7 further comprising collecting said upper portions in a bin below said tray.
